(19) United States
(12) Patent Application Publication
(10) Pub. No.: US 2015/0015049 A1
(43) Pub. Date: Jan. 15, 2015

(54) ADJUSTABLE HEAD RESTRAINT ASSEMBLY

(71) Applicant: LEAR CORPORATION, Southfield, MI (US)

(72) Inventors: Karsten MUELLER, Ingolstadt (DE); Frank KUNERT, Ingolstadt (DE); Michael RIEGER, Munich (DE); Zdzislaw SOBIESKI, Eching (DE)

(73) Assignee: LEAR CORPORATION, Southfield, MI (US)

(21) Appl. No.: 14/289,744

(22) Filed: May 29, 2014

(30) Foreign Application Priority Data
Jul. 9, 2013 (DE) 10 2013 107 254.2
Feb. 24, 2014 (DE) 10 2014 203 281.4

(51) Int. Cl. B60N 2/48

(52) U.S. Cl. CPC B60N 2/4829
USPC 297/410

(57) ABSTRACT

A head restraint assembly is provided with at least one guide post fixedly mounted to a vehicle seat back so that the guide post does not translate relative to the seat back in an upright direction. A head restraint housing is mounted to translate in the upright direction along the guide post. A linear spindle extends in the upright direction and is mounted within the head restraint housing. A translation assembly is mounted to the linear spindle. A motor is connected to the translation assembly. Actuation of the motor moves the translation assembly and motor in relation to the linear spindle. At least one of the motor or linear spindle is fixed to the head restraint housing such that actuation of the motor translates the head restraint housing relative to the guide post.

### CROSS-REFERENCE TO RELATED APPLICATIONS

This application claims priority to German Application 10 2013 107 254.2 filed Jul. 9, 2013 and German Application No. 10 2014 203 281.4 filed Feb. 24, 2014; the disclosures of which are hereby incorporated in their entirety by reference herein.

### TECHNICAL FIELD

Various embodiments relate to adjustable vehicle head restraint assemblies.

### BACKGROUND

Vehicle seats are often provided with movable head restraints, which can move to accommodate a head of an occupant and/or can move to various stowed positions to provide a compact seat in a stowed position.

### SUMMARY

According to at least one embodiment, a head restraint assembly is provided with at least one guide post fixedly mounted to a vehicle seat back so that the guide post does not translate relative to the seat back in an upright direction. A head restraint is mounted to translate in the upright direction along the guide post. A linear spindle extends in the upright direction and is mounted within the head restraint. A translation assembly is mounted to the linear spindle. A motor connected to the translation assembly. Actuation of the motor moves the translation assembly and motor in relation to the linear spindle. At least one of the motor or linear spindle is fixed to the head restraint such that actuation of the motor translates the head restraint relative to the guide post.

In another embodiment, the linear spindle is fixed within the head restraint housing such that the spindle does not rotate or translate relative to the housing.

In another embodiment, the linear spindle includes s a flexible spindle, wherein the flexible spindle is fixed to the head restraint housing at a distal end of the flexible spindle.

In another embodiment, the motor is fixedly mounted to the crossbar such that actuation of the motor translates the head restraint housing relative to the guide post as the spindle is moved relative to the translation assembly.

In another embodiment, the linear spindle includes a rigid spindle, wherein the rigid spindle is fixed to the head restraint housing at a distal end and wherein the motor is fixedly mounted to the crossbar such that actuation of the motor translates the head restraint housing relative to the guide post as the spindle is moved relative to the translation assembly.

In another embodiment, the motor is fixedly mounted to the head restraint housing such that actuation of the motor translates the head restraint housing relative to the guide post as the spindle is moved relative to the translation assembly.

In another embodiment, the linear spindle cooperates with a gear in the translation assembly, wherein the head restraint housing is generally infinitely adjustable along an adjustment range of the linear spindle.

In another embodiment the at least one guide post includes a pair of guide posts spaced apart in a lateral direction and connected by a crossbar.

According to at least another embodiment, a head restraint assembly is provided with a pair of guide posts are fixedly mounted to a vehicle seat back so that the guide posts do not translate relative to the seat back in an upright direction. A head restraint housing is mounted to translate in the upright direction along the guide posts. A crossbar connects the pair of guide posts. A linear spindle extends in the upright direction and fixed within the head restraint housing such that the spindle does not rotate. A translation assembly mounted to the spindle. A motor is connected to the translation assembly. Actuation of the motor moves the translation assembly and motor in relation to the linear spindle. The motor is fixedly mounted to the crossbar such that actuation of the motor translates the head restraint housing relative to the guide post as the spindle is moved relative to the translation assembly.

According to at least one other embodiment, a vehicle assembly is provided with a seat back and at least one guide post fixedly mounted to the seat back so that the guide post does not translate relative to the seat back in an upright direction. A head restraint is mounted to translate in the upright direction along the guide post. A linear spindle extends in the upright direction and is mounted within the head restraint. A translation assembly is mounted to the linear spindle. A motor connected to the translation assembly. Actuation of the motor moves the translation assembly and motor in relation to the linear spindle. At least one of the motor or linear spindle is fixed to the head restraint such that actuation of the motor translates the head restraint relative to the guide post, and thereby adjusting the head restraint relative to the seat back.

### BRIEF DESCRIPTION OF THE DRAWINGS

FIG. 1 illustrates a front perspective view of a portion of an adjustable head restraint assembly according to an embodiment;

FIG. 2 illustrates another front perspective view of a portion of the head restraint assembly of FIG. 1 illustrated in a lowered position;

FIG. 3 illustrates another front perspective view of a portion of the head restraint assembly of FIG. 2 illustrated in a raised position;

FIG. 4 illustrates a portion of the head restraint assembly of FIG. 1 in more detail;

FIG. 5 illustrates a front perspective view of a portion of an adjustable head restraint assembly according to another embodiment; and

FIG. 6 illustrates a front perspective view of a portion of an adjustable head restraint assembly according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Referring to the Figures, a movable head restraint assembly is illustrated and referenced generally by numeral 10. The head restraint assembly 10 is provided adjacent a seatback of a vehicle seat; and may be mounted directly to the vehicle seat or directly to the vehicle body adjacent the seatback for supporting the head of an occupant. The seat assembly may be for a vehicle such as a car, truck, aircraft, or any suitable vehicle requiring a head restraint. The movable head restraint assembly 10 is illustrated including a head restraint 12 provided upon a support post 14.

The support post 14 may be fixed relative to the vehicle or the vehicle seat back. For example, one or more support posts 14 may extend from the head restraint 12. Moreover, the support post 14 may be formed integrally with another support post 14 with a crossbar 16 interconnecting and spacing apart the support posts 14. The support posts 14 may be made of any suitable material or materials such as a metal or metal alloy.

In the movable head restraint system 10, the support posts 14 are generally fixed and do not move relative to the seatback. The fixed support posts 14 may provide aesthetic advantages such as no visible notches in the support posts, for example. In addition, since the support posts 14 do not extend into the seatback for adjustability, there may be extra space in the seatback or the seatback may be smaller to enable extra space for rear row passengers.

The head restraint 12 may include a trim cover (not shown) for enclosing foam (also not shown), a housing 18, and upright adjustment mechanism 30. The housing 18 may be molded of plastic or formed of any suitable material. The housing 18 may include a pair of shells which are sized to mate and retained the components of the head restraint 12 therein. In the Figures, one shell, such as a front portion, may be illustrated removed.

As illustrated in the Figures, the housing 18 may include guide bushings 22. The support posts 14 are adapted to move in the up and down in the upright direction Z along the guide bushings 22. The guide bushings 22 may be integrally formed in the housing 18 or attached separately to the housing 18.

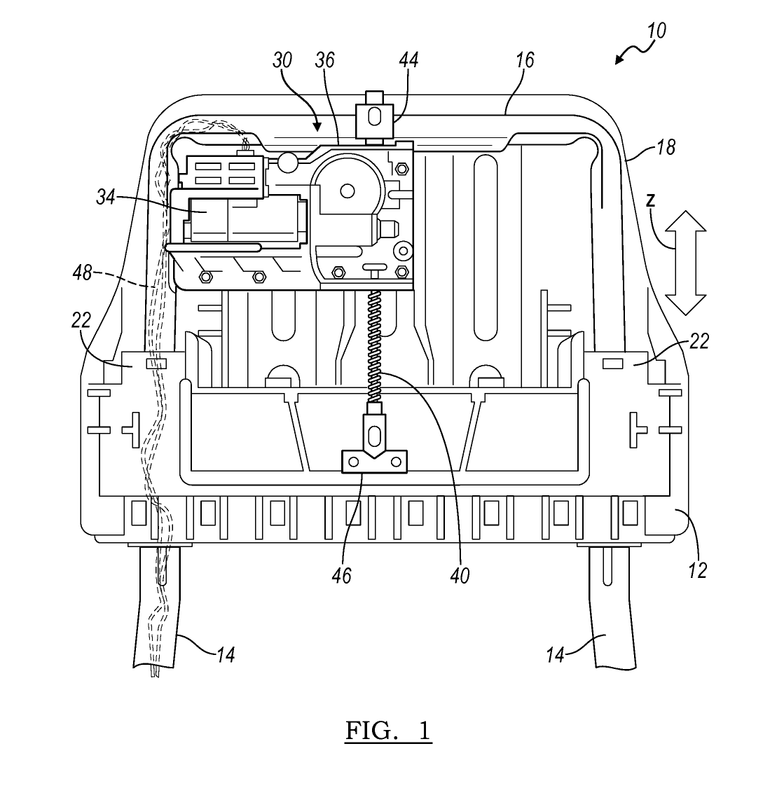

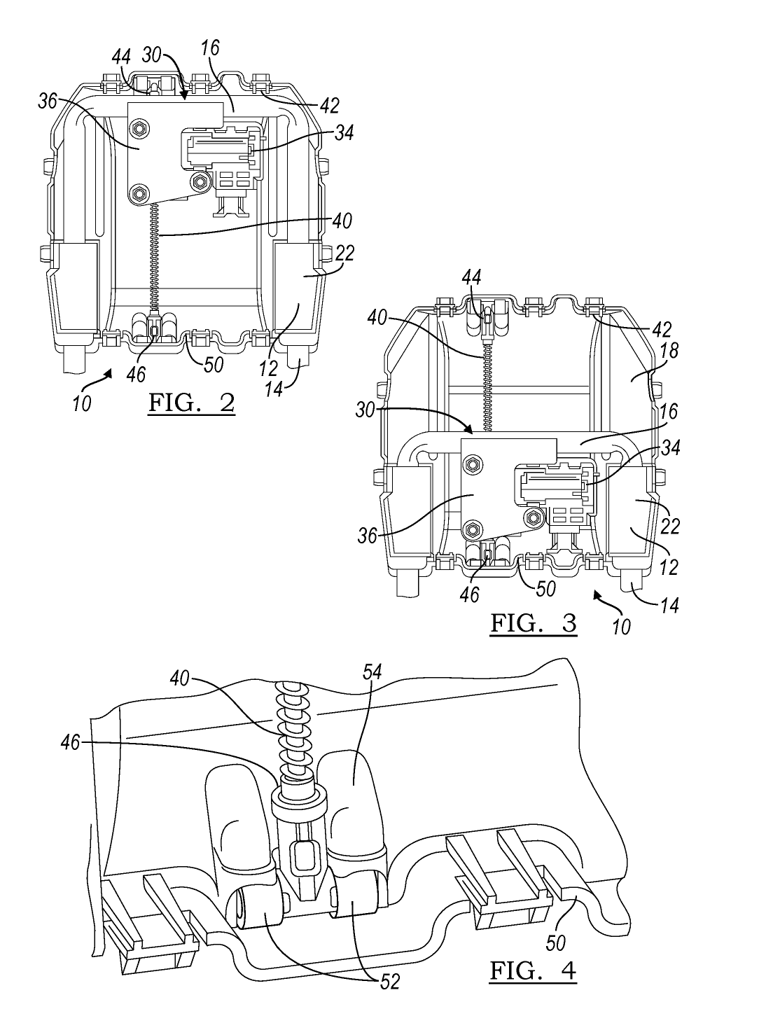

In FIGS. 1-2, the head restraint 12 is illustrated at a limit in one direction, the lowered direction, relative to the vehicle. In FIGS. 3, the head restraint 12 is illustrated a raised direction, relative to the vehicle. By actuating the adjustment mechanism 30, the occupant may move the head restraint 12 in the upright direction Z from the lowered position to the raised position, or to multiple, non-incremental positions therebetween.

The adjustment mechanism 30 includes a motor 34 and transmission assembly 36. The adjustment mechanism 30 is mounted to the upper crossbar 16. The adjustment mechanism 30 may be mounted to the crossbar 16 along the motor 34 and/or the transmission assembly 36. The adjustment mechanism also includes a stationary spindle 40. As illustrated, the spindle 40 is connected to a housing 18 at a pair of spindle ends 44, 46. Alternatively, the spindle 40 may be connected at only one of the distal spindle ends, such as the upper spindle end 44 or lower spindle end 46.

The spindle 40 may be made of a flexible or rigid material. A flexible spindle may be able to flex or bend somewhat along the length. In contrast, a rigid spindle may not flex or bend.

The spindle 40 passes through and is engaged with the transmission assembly 36. The head restraint housing 18 cooperates with the support posts 14 so that the housing translates along the support posts 14. The motor 34 drives the transmission assembly 36, which consequently drives the transmission assembly 36 along the spindle 40 thereby moving head restraint housing 18 relative to the upper crossbar 16 for adjustment of the head restraint 10 in the upright direction Z.

FIG. 3 illustrates the head restraint housing 18 in a raised position. The spindle 40 does not rotate, a gear in the transmission assembly 36 runs along the spindle 40. As transmission assembly 36 moves along the spindle 40, the spindle 40 extends beyond the crossbar 16. The spindle 40 may extend through the crossbar 16. In the raised position, an upper surface 42 extends away from the crossbar 16, thereby raising the head restraint 10.

In the raised position, the crossbar 16 is positioned adjacent to the guide bushings 22. A raised limit position may be defined when the crossbar 16 abuts the guide bushings 22 or when the transmission assembly 36 abuts a lower surface 43 of the housing 18 or the lower spindle end 46 or any other stop feature.

FIG. 2 illustrates the housing 18 in a lowered position. In the lowered limit position, the upper surface 42 of the housing 18 moves towards the crossbar 16. A lowered limit position may be defined when the crossbar 16 abuts the upper surface 42 of the housing 18 or any other stop feature. The head restraint 12 may move from 40-80 millimeters in the upright direction Z. However, a larger or smaller range may be dependent on the size of the head restraint housing 18 and the length of the spindle 40.

Wires 48 for providing power to the motor 34 may be guided through the support post 14. Since the motor 36 is attached to the crossbar 16, there is no relative movement between the wires 48 and the support posts 14.

FIG. 4 illustrates the spindle ends 46 in more detail. The lower spindle end 46 is illustrated; however, the upper spindle end 44 may be similar. The spindle end 46 includes a tab 52, or a pair of tabs 52 that cooperate with the housing 18 to retain the spindle 40. The housing 18 includes a retention feature 54 to cooperate with the tabs 52. The retention feature 54 may be a slot or groove integrally formed in the housing 18 to correspond with the tabs 52, or any suitable retention device attached to or formed in the housing 18.

The spindle adjustment mechanism 30 provides numerous benefits over prior upright adjustable head restraints. The motor 34 and gears in the transmission assembly 36 are compact and lightweight. The spindle 40 and transmission assembly 36 provide nearly silent operation. The spindle 40 teeth and gears of the transmission assembly 36 provide generally infinite variations of adjustments along the adjustment range. Also, since the adjustment mechanism 30 is provided in the head restraint 12 instead of in the seatback, there is greater interchangeability with the head restraint assembly 10 which may provide greater manufacturing flexibility for vehicle seats and cost savings.

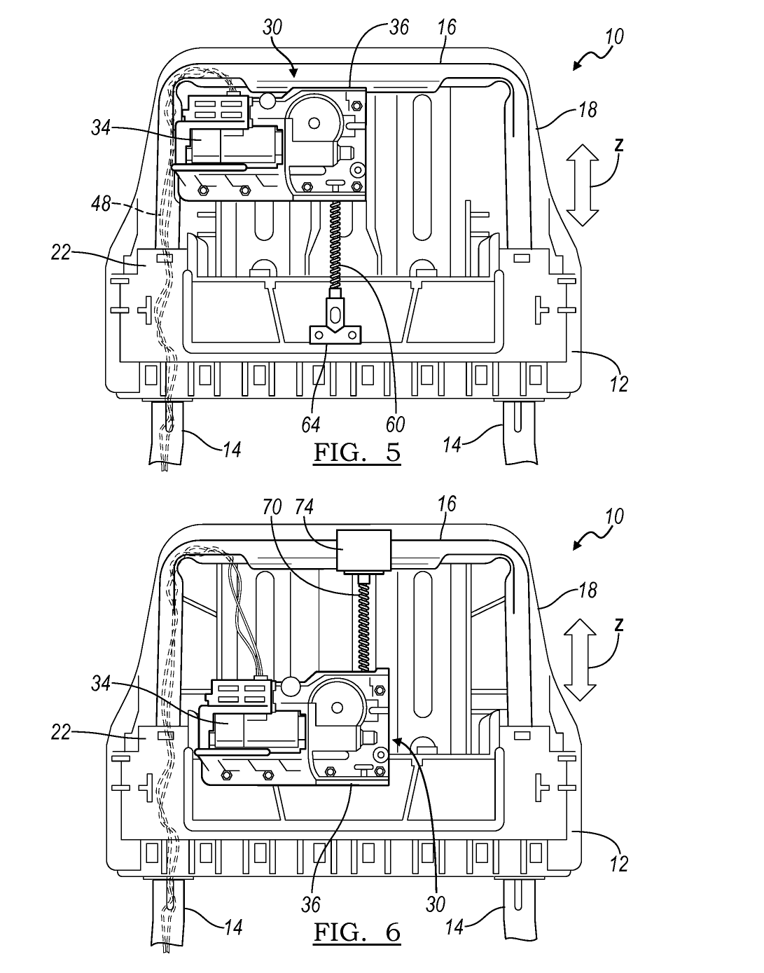

FIG. 5 illustrates another embodiment of the present disclosure for an adjustable head restraint assembly 10. In the embodiment illustrated in FIG. 5, the adjustment mechanism 30 includes a spindle 60. The adjustment mechanism 30 includes a motor 34 and transmission assembly 36. The adjustment mechanism 30 is mounted to the upper crossbar 16. The adjustment mechanism 30 may be mounted to the crossbar 16 along the motor 34 and/or the transmission assembly 36. As illustrated, the spindle 60 is connected to a housing 18 at a single spindle end 64. Alternatively, the spindle 60 may be connected at a pair of distal spindle ends.

As illustrated in FIG. 5, the spindle 60 is only connected to the housing 18 at one end 64 and spindle 60 can take loads in at least two directions. In the embodiment where only one spindle end 64 is utilized, there may be less tolerance issues.

The spindle 60 may be made of a flexible or rigid material. A flexible spindle may be able to flex or bend somewhat along the length. In contrast, a rigid spindle may not flex or bend.

The spindle 60 passes through and is engaged with the transmission assembly 36. The head restraint housing 18 cooperates with the support posts 14 so that the housing translates along the support posts 14. The motor 34 drives the transmission assembly 36, which consequently drives the spindle 60 through the transmission assembly 36 thereby moving head restraint housing 18 relative to the upper crossbar 16 for adjustment of the head restraint 10 in the upright direction Z.

FIG. 6 illustrates another embodiment of the present disclosure for an adjustable head restraint assembly 10. In the embodiment illustrated in FIG. 6, the motor 34 and translation assembly 36 are mounted to the housing 18. The adjustment assembly 30 includes a rotating spindle 70. The motor 34 turns the spindle 70. The spindle 70 runs through a spindle nut 74. The spindle 70 rotates through the spindle nut 74.

The spindle 70 may be made of a flexible or rigid material. A flexible spindle may be able to flex or bend somewhat along the length. In contrast, a rigid spindle may not flex or bend.

The motor 34 drives the transmission assembly 36, which consequently moves the motor 34 and housing along the spindle 70, thereby moving head restraint housing 18 relative to the upper crossbar 16 for adjustment of the head restraint 10 in the upright direction Z.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A head restraint assembly comprising:
at least one guide post fixedly mounted to a vehicle seat back so that the guide post does not translate relative to the seat back in an upright direction;
a head restraint housing mounted to translate in the upright direction along the guide post;
a linear spindle extending in the upright direction and mounted within the head restraint housing;
a translation assembly mounted to the linear spindle; and
a motor connected to the translation assembly, wherein actuation of the motor moves the translation assembly and motor in relation to the linear spindle,
wherein at least one of the motor or linear spindle is fixed to the head restraint housing such that actuation of the motor translates the head restraint housing relative to the guide post.

2. The head restraint assembly of claim 1 wherein the linear spindle is fixed within the head restraint housing such that the spindle does not rotate or translate relative to the housing.

3. The head restraint assembly of claim 2 wherein the linear spindle comprises a flexible spindle, wherein the flexible spindle is fixed to the head restraint housing at a distal end of the flexible spindle.

4. The head restraint assembly of claim 3 wherein the motor is fixedly mounted to the crossbar such that actuation of the motor translates the head restraint housing relative to the guide post as the spindle is moved relative to the translation assembly.

5. The head restraint assembly of claim 2 wherein the linear spindle comprises a rigid spindle, wherein the rigid spindle is fixed to the head restraint housing at a distal end and wherein the motor is fixedly mounted to the crossbar such that actuation of the motor translates the head restraint housing relative to the guide post as the spindle is moved relative to the translation assembly.

6. The head restraint assembly of claim 2 wherein the motor is fixedly mounted to the head restraint housing such that actuation of the motor translates the head restraint housing relative to the guide post as the spindle is moved relative to the translation assembly.

7. The head restraint assembly of claim 1 wherein the linear spindle cooperates with a gear in the translation assembly, wherein the head restraint housing is generally infinitely adjustable along an adjustment range of the linear spindle.

8. The head restraint assembly of claim 1 wherein the at least one guide post includes a pair of guide posts spaced apart in a lateral direction and connected by a crossbar.

9. A head restraint assembly comprising:
a pair of guide posts fixedly mounted to a vehicle seat back so that the guide posts do not translate relative to the seat back in an upright direction;
a head restraint housing mounted to translate in the upright direction along the guide posts;
a crossbar connecting the pair of guide posts;
a linear spindle extending in the upright direction and fixed within the head restraint housing such that the spindle does not rotate;
a translation assembly mounted to the spindle; and
a motor connected to the translation assembly, wherein actuation of the motor moves the translation assembly and motor in relation to the linear spindle,
wherein the motor is fixedly mounted to the crossbar such that actuation of the motor translates the head restraint housing relative to the guide post as the spindle is moved relative to the translation assembly.

10. The head restraint assembly of claim 9 wherein the linear spindle comprises a flexible spindle, wherein the flexible spindle is fixed to the head restraint housing at a first distal end and a second distal end.

11. The head restraint assembly of claim 9 wherein the linear spindle cooperates with a gear in the translation assembly, wherein the head restraint housing is generally infinitely adjustable along an adjustment range of the linear spindle.

12. A vehicle seat assembly comprising:
a seat back;
at least one guide post fixedly mounted to the seat back so that the guide post does not translate relative to the seat back in an upright direction;
a head restraint mounted to translate in the upright direction along the guide post;
a linear spindle extending in the upright direction and mounted within the head restraint;
a translation assembly mounted to the linear spindle; and
a motor connected to the translation assembly, wherein actuation of the motor moves the translation assembly and motor in relation to the linear spindle,
wherein at least one of the motor or linear spindle is fixed to the head restraint housing such that actuation of the motor translates the head restraint relative to the guide post, and thereby adjusting the head restraint relative to the seat back.

13. The vehicle seat assembly of claim 12 wherein the linear spindle is fixed within the head restraint such that the spindle does not rotate or translate relative to the housing;

14. The vehicle seat assembly of claim 13 wherein the linear spindle comprises a flexible spindle, wherein the flexible spindle is fixed to the head restraint at a first distal end and a second distal end.

15. The vehicle seat assembly of claim 14 wherein the motor is fixedly mounted to the crossbar such that actuation of the motor translates the head restraint relative to the guide post as the spindle is moved relative to the translation assembly.

16. The vehicle seat assembly of claim 13 wherein the linear spindle comprises a rigid spindle, wherein the rigid spindle is fixed to the head restraint at a distal end and wherein the motor is fixedly mounted to the crossbar such that actuation of the motor translates the head restraint relative to the guide post as the spindle is moved relative to the translation assembly.

17. The vehicle seat assembly of claim 13 wherein he motor is fixedly mounted to the head restraint such that actuation of the motor translates the head restraint relative to the guide post as the spindle is moved relative to the translation assembly.

18. The vehicle seat assembly of claim 12 wherein the linear spindle cooperates with a gear in the translation assembly, wherein the head restraint is generally infinitely adjustable along an adjustment range of the linear spindle.

19. The vehicle seat assembly of claim 12 wherein the at least one guide post includes a pair of guide posts spaced apart in a lateral direction and connected by a crossbar.
